(19) United States
(12) Patent Application Publication
(10) Pub. No.: US 2012/0275992 A1
(43) Pub. Date: Nov. 1, 2012

(54) Dual Purpose Gas Purification by Using Pressure Swing Adsorption Columns for Chromatographic Gas Separation

(76) Inventor: Juzer Jangbarwala, Chino Hills, CA (US)

(21) Appl. No.: 13/371,290

(22) Filed: Feb. 10, 2012

Related U.S. Application Data
(63) Continuation-in-part of application No. 12/953,116, filed on Nov. 23, 2010, now abandoned.
(60) Provisional application No. 61/263,993, filed on Nov. 24, 2009.

(51) Int. Cl. C01B 3/26

(52) U.S. Cl. 423/654; 423/652; 423/653

(57) ABSTRACT

A process wherein a gas mixture of a reformate gas comprised predominantly of hydrogen and carbon oxides, and a biogas comprised predominantly of methane and carbon dioxide is passed through a pressure swing adsorption unit. Contaminants, such as carbon oxides, are adsorbed and a methane-rich stream and a hydrogen-rich stream are separately recovered. The methane-rich stream is sent to steam methane reforming that results in a reformate comprised primarily of hydrogen which is then combined with the biogas feed stream and sent to pressure swing adsorption.

### CROSS-REFERENCE TO RELATED APPLICATIONS

The application is a continuation-in-part of U.S. Ser. No. 12/953,116 filed Nov. 23, 2010 which is based on Provisional Application 61/263,993 filed Nov. 24, 2009.

### FIELD OF THE INVENTION

The present invention relates to a process wherein a gas mixture of a reformate gas comprised predominantly of hydrogen and carbon oxides, and a biogas comprised predominantly of methane and carbon dioxide is passed through a pressure swing adsorption unit. Contaminants, such as carbon oxides, are adsorbed and a methane-rich stream and a hydrogen-rich stream are separately recovered. The methane-rich stream is sent to steam methane reforming that results in a reformate comprised primarily of hydrogen which is then combined with the biogas feed stream and sent to pressure swing adsorption.

### BACKGROUND OF THE INVENTION

Electricity generation from biogas is seen as having significant potential in the field of alternative energy. Biogas is typically produced by the anaerobic digestion, or fermentation, of biodegradable materials such as a biomass including manure, sewage, municipal waste, green waste, plant materials, and crops. Biogas is typically comprised primarily of methane and carbon dioxide but may have smaller amounts of other components such as hydrogen sulfide, moisture, and siloxanes. It can be utilized as a renewable energy source in combined heat and power plants, as a vehicle fuel, or as a substitute for natural gas.

Biogas from such sources has typically been fed directly to internal combustion engines (ICEs). These engines, which are usually modified to operate on low methane content fuels, convert about 30% of the energy of the biogas to electricity, and the rest to waste heat. Such fuels can have BTU values as low as about 450 BTUs per standard cubic foot compared to 930 to 1100 for pipeline natural gas. Examples of such ICEs include Guascor SFGLD series, Caterpillar G3520, and Jenbacher J-312. These engines typically cannot be run at the very high air to gas ratios required for low emissions of nitrogen oxides (NOx). Consequently, they usually generate significant levels of (NOx), which is considered to be >300 times more potent as greenhouse gases than CO₂. This creates a dilemma for renewable energy plants, and more so for air quality permitting agencies. On the one hand, it is beneficial to substitute fossil fuel energy with waste methane, but on the other, the combustion process deployed creates toxic emissions. Therefore, the industry is employing a variety of methods to lower NOx emissions.

Of the several options available to industry, one of the simpler ones is to substitute fuel cells for ICEs. Another option is to generate hydrogen in-situ and inject it directly into an ICE to allow “leaner” air mixtures. Yet another option is to convert a conventional ICE to a 100% hydrogen fueled engine. All these options require efficient in-situ hydrogen production. Methane Steam Reforming (MSR) is a preferred process for the production of hydrogen. Since methane is generally the major component of biogas, on-site hydrogen generation is a viable path for greener energy. Catalytic methane cracking is another process deployed for the generation of so-called green, or zero-carbon, hydrogen footprint.

Generally, two separate gas purification steps are required for the production of hydrogen from biogas by conventional methods. First, the biogas must be purified to yield greater than 90 vol. % methane with substantially no sulfur or siloxane compounds to avoid poisoning of a downstream reforming catalyst. Second, the product of steam reforming, commonly referred to as the “reformate”, must be purified to yield a substantially pure (>99.99%) hydrogen stream for feed to a fuel cell, or ICE. A preferred conventional process used for both these separations is pressure swing adsorption (PSA).

While PSA systems have been modified in many ways to increase efficiency for the purification of a single gas stream, such as simulated dynamic bed, and moving beds, there remains a need in industry to utilize a single PSA system for purification of two feedstream simultaneously.

### SUMMARY OF THE INVENTION

In accordance with the present invention there is provided a process for producing hydrogen from a biogas feedstream containing methane, which process comprises:

a) conducting a biogas feedstream containing methane through a pressure swing adsorption process unit containing a first adsorbent which is selective toward methane and a second adsorbent with is selective toward hydrogen thereby resulting in an initial methane-rich product stream;

b) conducting at least a portion of said initial methane-rich product stream to a steam methane reforming zone where it is reacted under reforming conditions in the presence of a steam methane reforming catalyst thereby resulting in the conversion of said methane-rich product stream to a reformate gaseous stream comprised predominantly of hydrogen and carbon monoxide;

c) recycling at least a portion of said reformate gaseous stream to said biogas feedstream wherein a mixed stream of the two results;

d) conducting said mixed stream through said pressure swing adsorption process unit thereby resulting in a methane-rich product stream and a hydrogen-rich product stream;

e) collecting said hydrogen-rich product stream; and

f) conducting said methane-rich product stream to said steam methane reforming zone wherein a reformate gaseous stream comprised predominantly of hydrogen and carbon monoxide is produced; and

g) repeating steps c) through f) above thereby resulting in a continuous process.

In a preferred embodiment the adsorbents are selected from the group consisting of activated carbon, carbon molecular sieves, zeolitic materials, silica gel, and alumina.

In another preferred embodiment the biogas is a landfill gas comprised of at least about 50 vol. % methane.

In yet another preferred embodiment the steam methane reforming is operated at a temperature from about 300° C. to 900° C. and at pressures from about 15 to 150 psig.

In another preferred embodiment the catalyst used for steam methane reforming is comprised of a metal selected from the group consisting of nickel, cobalt, platinum, ruthenium or mixtures thereof on a support selected from the group consisting of carbon, alumina, silica and alumina-silica.

### BRIEF DESCRIPTION OF THE FIGURE

FIG. 1/1 is a schematic representation of a preferred embodiment for practicing the present invention.

### DETAILED DESCRIPTION OF THE INVENTION

This description will enable one skilled in the art to make and use the present invention, and it describes several embodiments, adaptations, variations, alternatives, and uses of the present invention, including what is presently believed to be the best mode of carrying out the invention.

As used in this specification and the appended claims, the singular forms “a”, “an”, and “the” include plural referents unless the context clearly indicates otherwise. Unless defined otherwise, all technical and scientific terms used herein have the same meaning as in commonly understood by one of ordinary skill in the art to which this invention belongs.

Unless otherwise indicated, all numbers expressing reaction conditions, stoichiometries, concentrations or components, and so forth used in the specification and claims are to be understood as being modified in all instances by the term “about”. Accordingly, unless indicated to the contrary, the numerical parameters set forth in the following specification and attached claims are approximations that may vary depending at least upon a specific analytical technique.

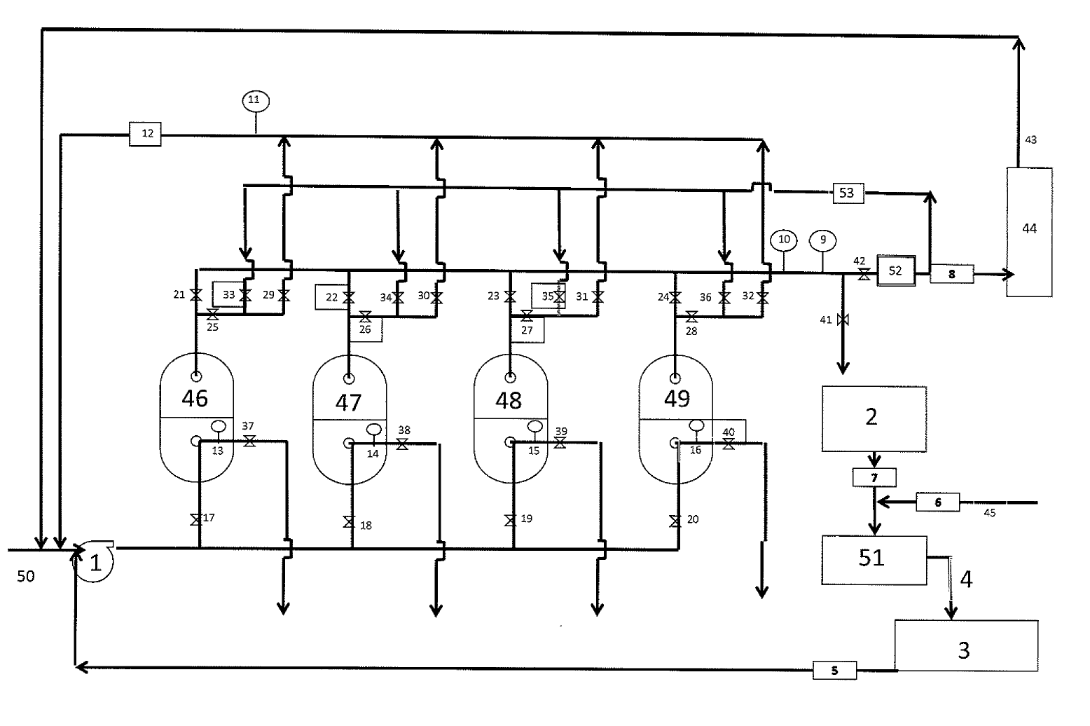

The present invention relates to an integrated system comprising two main process units—a PSA unit and a methane steam reforming unit. A biogas feed containing methane is passed through the PSA unit wherein a methane-rich stream results. Although the precise composition of the biogas will depend on its source, biogas in general will be comprised of about 50 to 75 vol. % methane, 25 to 50 vol. %, with lesser, if any, amounts of contaminants such as water, particulates, hydrogen sulfide, nitrogen, hydrogen and siloxanes. One particularly preferred biogas feed of the present invention is landfill gas (LFG) also sometimes referred to as digester gas. Raw landfill gas typically has methane concentrations around 50 vol. %. The methane-rich stream is sent to a methane steam reformer wherein a reformate comprised primarily of hydrogen and carbon monoxide is produced. At least a portion of this reformate stream is conducted to the biogas feed wherein the resulting mixed stream is passed through the same PSA unit wherein a methane-rich stream and a hydrogen-rich stream are separately produced. The hydrogen-rich stream can be collected or directly used as feed to an energy device, such as an internal combustion engine (ICE) or fuel cell system. The PSA unit will preferably be comprised of a plurality of vessels each containing a bed of adsorbent material. The adsorbent bed will preferably contain two different adsorbent materials. One adsorbent material will be selective for methane and another will be selective for hydrogen. It is also preferred that the adsorbent material be positioned in at least one adsorption vessel in layers. That is, one or more layers will be an adsorbent material selective for methane and one or more different layers will be selective for hydrogen. Thus, it is an object of the present invention to combine the two PSA systems (two different adsorbents) into a single process unit in fluid communication with the hydrogen generation system (methane reformer). This single unit will utilize the appropriate adsorbent material for the intended two gas separation. Details of such a system are described below with reference to FIG. 1/1 hereof.

In a PSA process, a gaseous stream is passed under pressure for a period of time over a bed of a solid adsorbent material that is selective, or relatively selective, for a particular component, usually regarded as a contaminant, that is to be removed from the gas stream. The gas components (gas species) tend to be adsorbed within the pore structure of the adsorbent material, or within the free volume of a polymeric material (if used as the adsorbent material). The preferred adsorbent material will be a microporous material. The higher the pressure, the more targeted gas component will be adsorbed. When the pressure is reduced, the adsorbed gaseous components will be released, or desorbed. PSA processes can be used to separate one or more gas species from a mixture of gas species because different gas species tend to fill the micropore, or free volume, of the adsorbent to different extents. The gaseous stream is passed over the adsorbent bed and emerges from the bed depleted in the contaminant that remains adsorbed in the bed. PSA is typically operated at near-ambient temperatures and thus differs from technologies such as cryogenic distillation gas separation. Special adsorptive materials (e.g. zeolites) are used as a molecular sieve, preferentially adsorbing the target gaseous components at high pressure. The process swings to low pressure to desorb the adsorbent material. Heat can also be used to enhance desorption of adsorbed species. If a gas mixture such as air, for example, is passed under pressure through a vessel containing a bed of an adsorbent material that is selective for attracting (adsorbing) nitrogen more strongly than it does oxygen, at least a fraction, preferably substantially all, of the nitrogen will stay in the bed, and the gaseous stream exiting the vessel will be enriched in oxygen and depleted in nitrogen. When the bed reaches the end of its capacity to adsorb nitrogen, it is regenerated by reducing the pressure, by applying heat, or both thereby releasing at least a fraction, preferably substantially all, of the adsorbed nitrogen. It is then ready for another cycle of producing an oxygen enriched stream. Using two adsorbent vessels allows near-continuous production of the desired purified gaseous stream. It also permits pressure equalization, where the gas leaving the vessel being depressurized is used to partially pressurize the second vessel. This results in significant energy savings, and is conventional industrial practice. It is preferred that at least four adsorbent vessels be used.

PSA processes are primarily comprised of the following steps:

1) Adsorption stage (service): In this stage, the least adsorbed gas is recovered from the mixed gas stream at relatively high purity. The feed gas is typically fed at the bottom of an adsorbent column and a relatively high purity gaseous component exits the top.
2) Upon “exhaustion”, determined either by a timed cycle (with consistent feed streams, such as air) or by breakthrough determined by a gas analysis sensor, the bed is regenerated. Feed flow is typically then diverted to a standby column. The first stage of the regeneration generally involves a “co-current” and staged depressurization of the adsorption column. Using multiple stages to de-pressurize the column allows the removal of any purified gas to be collected at high recovery. If the column is rapidly depressurized, the adsorbed gaseous components do not have enough time to diffuse out of the “void” spaces and will become contaminated by the rapid “desorption” of the (undesired) adsorbed components.
3) Staged depressurization is typically stopped at a pressure midway between service and atmospheric. The bed is then depressurized “counter-currently” to service flow by simply venting to the atmosphere that may include a “flare” to burn any flammable gas.
4) The column, which is now at atmospheric pressure, is “purged” at low pressure, in counter-current mode with the desired high purity gas. Although an inert gas can be used, the gas for this step is usually taken from the service outlet of the particular working adsorbent bed with the pressure regulated downward.
5) After the purge cycle, the bed is then re-pressurized, using service gas flow of the purified gas, and then put on standby. The total cycle time is the length of time from when the gaseous mixture is first conducted to the first bed in a first cycle to the time when the gaseous mixture is first conducted to the first bed in the immediately succeeding cycle, i.e., after a single regeneration of the first bed. The use of third, fourth, fifth, etc. vessels in addition to the second vessel can serve to increase cycle time when adsorption time is short but desorption time is long.

The present invention is better understood with reference to FIG. 1/1 hereof which shows a PSA process unit containing 4 adsorbent beds 46, 47, 48, and 49. Although at least four beds are preferred, the number of beds is not limited and depends on such things as the composition of the biogas, the level of desired purity, the desired cycle times, etc. The complete cycle of one bed 46 will be explained to the point of service switching to second bed 47 when 46 is exhausted. It should be clear to those skilled in the art that a similar sequence can be followed for beds 47-48, 48-49, and 49-46. It should also be clear to those skilled in the art that appropriate adsorbents and molecular sieves can be used either as the sole adsorbent or preferably in layers to facilitate the desired separation. Non-limiting examples of adsorbents used PSA process units include: activated carbon, carbon molecular sieves such as CMS-3K, zeolitic molecular sieves, silica gel, and alumina. Other non-limiting examples include zeolite 13X, 8-ring zeolites are typically used for CO₂ removal and can include DDR, Sigma-1 and ZSM-58. MFI, faujasite, MCM-41 and Beta can be used for heavier hydrocarbons.

Compressor 1 receives biogas feed via line 50, typically at pressures ranging from about 5 to about 30 psig, preferably at pressures from about 5 to 10 psig and pressurizes it to operating pressure. The biogas gas is fed, under pressure, to adsorption vessel 46 in an upflow direction. The adsorbent bed in vessel 46, as well in all other adsorption vessels, will establish a sequential, or layered, adsorption profile. It will adsorb the strongly adsorbed contaminants first, and such contaminants as CO₂ will occupy the bottom layer of the adsorbent bed. The adsorbent bed will also adsorb methane that will form the next layer above the more strongly adsorbed gaseous components. The adsorbent bed will adsorb very little hydrogen, as is typical for hydrogen purification PSA systems. On start-up on the biogas is fed to the PSA process unit and will contain little, if any, hydrogen. Only after a methane-rich stream is recovered and sent to a steam methane reforming stage will a reformate containing a substantial amount of hydrogen be produced which will be recycled to the biogas feedstream and sent through the PSA unit. The hydrogen, which present, will be the initial stream of product gas and will be monitored by gas analyzers 9, 10. The analyzers will continuously monitor the purity of hydrogen and methane. The purified hydrogen is sent through valve 42 into an equalization tank 52 having a volume sufficient to be able to continuously supply hydrogen to the intended use device, 44. When the product gas is predominantly methane it will be collected in storage tank 2. Hydrogen will be passed through a pressure regulator 8 to intended device 44. Intended device 44 can be any suitable device that is capable of using hydrogen as a fuel, or it can be a collection tank for storing hydrogen. Non-limiting examples of preferred devices that can use hydrogen includes fuel cells and internal combustion engines. Pressure regulator 8 will be capable of reducing the operating pressure of the hydrogen to 5 to 50 psig, particularly when the intended device is a fuel cell system. The hydrogen-rich stream exiting the PSA unit will be at a pressure from about 250 psig to about 500 psig.

If a fuel cell device is used as the intended device for the purified hydrogen product stream the concentration of contaminants, such as carbon monoxide, should be less than 5 ppm, and even more preferably less than 1 ppm. The fuel will typically be a fuel cell stack that will receive at least a portion of high purity hydrogen stream and an oxidant and produces an electric current therefrom. Non-limiting examples of suitable oxidants include air, oxygen gas, and oxygen-enriched air. The oxidant stream may be delivered to the fuel cell stack via any suitable mechanism. The fuel cell system may include additional components that are well known in the art, such as feed pumps, air delivery systems, heat exchangers, controllers, flow-regulating structures, sensor assemblies, heating assemblies, power management modules, and the like.

A fuel cell stack typically includes multiple fuel cells joined together between common end plates that contain fluid delivery/removal conduits. Examples of suitable fuel cells include proton exchange membrane (PEM) fuel cells and alkaline fuel cells. The hydrogen can also be stored in a suitable storage device designed for hydrogen gas, such as pressurized tanks and hydride beds. The electric current produced by fuel cell stack can be used to satisfy the energy demands, or applied load, of at least one associated energy-consuming device. Non-limiting examples of such energy-consuming devices include motor vehicles, recreational vehicles, industrial or construction vehicles, boat or other sea-craft, tools, lights or lighting assemblies, appliances (such as a household or other appliance), households, commercial offices or buildings, neighborhoods, industrial equipment, signaling or communication equipment, the balance-of-plant electrical requirements for the fuel cell system, etc. It is within the scope of the present invention that the fuel cell system may (but is not required to) include at least one energy-storage device that is adapted to store at least a portion of the current produced by fuel cell stack. For example, the current can establish a potential that may be later used to satisfy an applied load, such as from an energy-consuming device. Non-limiting examples of a suitable energy-storage device include batteries, ultra capacitors, and flywheels. An energy storage device can additionally or alternatively be used to power the fuel cell system, such as during startup of the system.

When sensors 9, 10 confirm the presence of a pre-determined concentration of methane, valve 42 is closed and valve 41 is opened to store the methane in tank 2. The methane is passed through pressure regulator 7 to maintain pressure required for methane steam reforming process unit 51 which will be from about 15 psig to about 150 psig. The regulated pressure methane stream from storage tank 2 will be mixed with steam via line 45 equal to the volume desired by the reformer, and passed through pressure regulator 6. Pressure regulators 6 and 7 will be set at substantially the same pressure. Reformate gas is conducted via line 4 from reformer 51 and sent to condenser 3 where excess steam is condensed. Dry hydrogen gas with other by-products of reforming 5 will be sent to a point on the biogas line 50, upstream of the compressor 1. The resulting mixture of biogas and reformate are sent through the PSA process unit wherein a hydrogen-rich stream is product stream and a methane-rich stream results. The methane-rich stream sent to the steam methane reformer and the process cycle is repeated in a continuous mode.

It will be understood that it may be preferred that the reformate gas be subjected to a water-gas shift reaction in which carbon monoxide reacts with water vapor to form carbon dioxide and hydrogen. The water-gas shift reaction is often performed in two stages wherein stage one is a high temperature shift (HTS) at about 350° C.-450° C. and stage two a low temperature shift (LTS) at a temperature from about 160° C. to about 250° C. Non-limiting examples of preferred water-gas shift catalysts include iron oxides particularly those promoted with chromium oxide, copper on a support comprised of zinc oxide with or without aluminum oxide. Water-gas shift processes are well known to those having ordinary skill in the art and a detailed discussion of the process is not necessary for purposes of the enabling the present invention. A disclosure of water-gas shift processes can be found in U.S. Pat. No. 7,824,656 which is incorporated herein in its entirety.

The catalyst used for the steam methane reforming reaction may comprise any of the catalytic metals known to be useful for steam methane reforming. Non-limiting examples of such metals include nickel, cobalt, platinum and ruthenium and mixtures thereof. The catalyst may be used in the form of a particulate bed or supported on an inert carrier support, such as carbon, alumina, silica and alumina-silica. The reformer will be operated at a temperature from about 300° C. to 900° C., preferably from about 400° C. to 800° C., at pressures from about 15 to 150 psig, preferably, from about 15 to 75 psig.

Any excess hydrogen, in the case of ICEs, or anode off gas (unused hydrogen), in the case of fuel cell from 44, shown as 43, can be sent to a point upstream of compressor 1 and merged with the biogas feed stream. When sensors 9,10 indicate the presence of a predetermined level of the undesired contaminant gas, bed 46 will be taken off line by closing valves 17 and 21, and bed 47 will be put on line by opening valve 18 and 22, and the sequence of hydrogen and methane collection as discussed for bed 46 will continue.

Bed 46 can be regenerated by first opening valve 25 and reducing the pressure in the vessel by about 40 to 50% of operating, or service pressure by sequential two or more steps. Pressure transmitter 11 controls the open and close timing of valve 29 to achieve about a 5 psig drop in pressure with each step. The purpose of this is to remove any methane trapped in the void space or between the adsorbent media granules. The gas will be connected via a vacuum breaker 12 to a point upstream of compressor 1. Once a drop in pressure of about 40 to 50% of operating pressure is achieved, valve 29 is closed and valve 37 is opened to achieve atmospheric pressure in a controlled, staged method, by a feedback loop from pressure transmitter 13, which is also shown as 14, 15, and 16, respectively for vessels 47, 48, and 49. The exhaust will be about atmospheric pressure and will contain the undesired contaminants, which can be directed to a flare or other method of suitable disposal.

While valve 37 is open, the bed will be purged with hydrogen from storage tank 52 using flow control 53. Sufficient hydrogen will be sent to 46 to purge any residual contaminants from the bed, and then valve 37 will be closed. The system will pressurize with hydrogen, equilibrating with the pressure in the hydrogen storage tank 52. Bed 46 will now be ready for the next cycle.

It will be understood that it is within the scope of this invention to use the type of steam reforming system disclosed in U.S. patent application Ser. No. 11/893,829 filed Aug. 17, 2077 and which is incorporated herein by reference. The stream reforming system disclosed in that the '829 application is directed to the use of novel permeable catalytic sheets that are subjected to an electric current as reactants are passed through it. The chemical reaction is enhanced by an electric field created by an electric current passing through the conductive carbon fibers of the permeable catalytic sheet. The permeable catalytic sheets are comprised of at least three distinct solid phases. The first solid phase is an electrically non-conductive phase characterized as being a 3-dimensional porous network, or matrix, of at least one ceramic material. A second solid phase is an electrically conductive phase that is comprised of a plurality of randomly oriented electrically conductive carbon fibers interspersed throughout at least a portion of the non-conductive first solid phase. The distribution of carbon fibers will be porous enough so that the pressure drop of a reactant gas passing through the finished catalytic sheet will be equal to or less than about 0.5 psig, preferably equal to or less than about 0.3 psig, and more preferably equal to or less than about 0.1 psig. A third solid phase is comprised of an effective amount of catalyst particles capable of catalyzing the intended chemical reaction. The catalyst particles can be present in bulk form (not on a carrier) or on a suitable carrier, such as a metal oxide, preferably alumina. The '829 application teaches that an effective amount of carbon nanostructures can be used as another additional solid phase. The carbon nanostructures, preferably graphitic nanostructures, can be used as a catalyst carrier or they can be used to enhance the conductivity of the resulting catalytic sheets. Non-limiting examples of preferred carbon nanostructures are those selected from carbon nanotubes, carbon fibrils, and carbon nanofibers. Typically, the nanostructure will be substantially graphitic, and in the case of carbon nanofibers and nanotubes, the most preferred nanostructures, the distance between graphitic platelets will be about 0.335 nm. It is to be understood that the terms “carbon filaments”, “carbon whiskers”, “carbon nanofibers”, and “carbon fibrils”, are sometimes used interchangeably by those having ordinary skill in the art. The more preferred carbon nanofibers are those having graphite platelets that are substantially perpendicular to the longitudinal axis of the nanofiber (“platelet” structure) and those wherein the graphite platelets are aligned substantially parallel to the longitudinal axis (“cylindrical” and “multifaceted” tubular). U.S. Pat. No. 6,537,515 to Catalytic Materials, LLC, which is incorporated herein by reference, teaches a method for producing a substantially crystalline graphite nanofiber comprised of graphite platelets that are aligned substantially perpendicular to the longitudinal axis of the nanofiber.

The most preferred carbon nanofibers having their graphite platelets aligned substantially parallel to the longitudinal axis are the non-cylindrical multifaceted tubular nanofibers. Such multi-faceted tubular nanofibers can be single or multi-walled, preferably multi-walled. By multi-walled we mean that the structure can be thought of a multi-faceted tube within a multi-faceted tube, etc. The multi-faceted tubular carbon nanostructures of the present invention are distinguished from the so-called “fibrils” or cylindrical carbon nanostructures. The multi-faceted tubular nanofibers of the present invention can also be thought of as having a structure that resembles a multi-faceted pencil or Alan key. That is, a cross section of the multifaceted nanotube would represent a polygon. A single wall of the multifaceted nanotubes of the present invention can also be thought of as being a single sheet folded in such a way to resemble a multifaceted tubular structure—the folds being the corners.

It is within the scope of this invention that the above disclosed graphite nanofibers, preferably the graphite platelet nanofibers, be used as an adsorbent material in the PSA process unit of the present invention.

What is claimed is:

1. A process for producing hydrogen from a biogas feedstream containing methane, which process comprises:
a) conducting a biogas feedstream containing methane through a pressure swing adsorption process unit containing a first adsorbent that is selective for methane and a second adsorbent that is selective for hydrogen, thereby resulting in an initial methane-rich product stream;
b) conducting at least a portion of said initial methane-rich product stream to a steam methane reforming zone where it is reacted under steam reforming conditions in the presence of a steam methane reforming catalyst thereby resulting in the conversion of at least a portion of the said methane-rich product stream to a reformate gaseous stream comprised predominantly of hydrogen and carbon monoxide;
c) recycling at least a portion of said reformate gaseous stream to said biogas feedstream wherein a mixed stream of the two results;
d) conducting said mixed stream through said pressure swing adsorption process unit thereby resulting in a methane-rich product stream and a hydrogen-rich product stream;
e) collecting said hydrogen-rich product stream; and
f) conducting said methane-rich product stream to said steam methane reforming zone wherein a reformate gaseous stream comprised predominantly of hydrogen and carbon monoxide is produced; and
g) repeating steps c) through f) above thereby resulting in a continuous process.

2. The process of claim 1 wherein the adsorbents are selected from the group consisting of activated carbon, carbon molecular sieves, zeolitic materials, silica gel, and alumina.

3. The process of claim 1 wherein the biogas is a landfill gas comprised of at least about 50 vol. % methane.

4. The process of claim 2 wherein the landfill gas contains at least about 20 vol. % carbon dioxide.

5. The process of claim 1 wherein the steam methane reforming is operated at a temperature from about 300° C. to 900° C. and at pressures from about 15 to 150 psig.

6. The process of claim 5 wherein the catalyst used for steam methane reforming is comprised of a metal selected from the group consisting of nickel, cobalt, platinum, ruthenium or mixtures thereof on a support selected from the group consisting of carbon, alumina, silica and alumina-silica.

7. The process of claim 1 wherein the hydrogen-rich product stream is comprised of substantially pure hydrogen is used to fuel a fuel cell system which is an integral part of the present process.

8. The process of claim 1 wherein the hydrogen-rich product stream is comprised of substantially pure hydrogen is used to fuel a internal combustion engine which an integral part of the present process.
